(19) United States
(12) Patent Application Publication
(10) Pub. No.: US 2014/0028893 A1
(43) Pub. Date: Jan. 30, 2014

(54) IMAGE CAPTURING APPARATUS AND METHOD OF CONTROLLING THE SAME

(71) Applicant: SAMSUNG ELECTRONICS CO., LTD., Suwon-si (KR)

(72) Inventors: Ki Oh Jung, Suwon-si (KR); Sang Kee Jung, Hwaseong-si (KR)

(21) Appl. No.: 13/943,960

(22) Filed: Jul. 17, 2013

(30) Foreign Application Priority Data
Jul. 25, 2012 (KR) 10-2012-0081488

(51) Int. Cl. H04N 5/232

(52) U.S. Cl. CPC H04N 5/23212
USPC 348/341; 348/352

(57) ABSTRACT

Disclosed herein are an image capturing apparatus and a method of controlling the same, by which images may be captured without direct contact with a main body of the image capturing apparatus and without purchasing and carrying an additional remote controller. The method of controlling the image capturing apparatus includes generating a first detection signal and a second detection signal in response to motion of an object within a detection region of an ocular sensor, controlling a focusing module to bring a subject into focus in response to the generation of the first detection signal, and controlling a shutter and an imaging device to capture an image of the subject in response to the generation of the second detection signal.

### CROSS-REFERENCE TO RELATED APPLICATION

This application claims the priority benefit of Korean Patent Application No. 2012-0081488, filed on Jul. 25, 2012 in the Korean Intellectual Property Office, the disclosure of which is incorporated herein by reference.

### BACKGROUND

1. Field

Embodiments of the invention relate to an image capturing apparatus, and more particularly, to an image capturing apparatus on which an ocular sensor configured to detect the approach of an object is mounted.

2. Related Art

A camera, which is an image capturing apparatus, may be an apparatus configured to record an image of a subject input through a lens on a film or an imaging device (e.g., a charge-coupled device (CCD) or complementary metal-oxide-semiconductor (CMOS) device). In the camera, the capturing of images may be performed in response to manipulation of a shutter-release button or manipulation of a remote controller configured to communicate with the camera in a wired or wireless manner. That is, a user may confirm a subject via a viewfinder or monitor disposed in a main body of the camera, and then manipulate the shutter-release button or the remote controller to capture images of the subject.

The manipulation of the shutter-release button may include applying a predetermined force using, for example, a finger, to the shutter-release button disposed in the main body of the camera. During the application of the predetermined force, the main body of the camera may shake. As a result, blurs may occur on the images, and the shape of the subject may become unclear. This phenomenon may be more serious when a shutter speed is reduced to increase the quantity of light in the case of a lack of light or night photography or low-illumination indoor photography.

The remote controller may be configured to enable a user to capture images without direct contact with the shutter-release button. The remote controller may include a receiving unit contained in the main body of the camera or additionally combined with the main body of the camera, and a transmission unit disposed in a position apart from the main body of the camera and configured to generate a shutter-release signal. The user may manipulate the transmission unit to generate the shutter-release signal, and the receiving unit of the main body of the camera may receive the shutter-release signal and provide the shutter-release signal to a controller of the main body of the camera so that the controller can perform control operations to drive a shutter. When the remote controller is used, images may be captured without direct contact with the main body of the camera, so shake of the camera may be prevented. However, since an additional remote controller should be purchased, additional costs may be incurred. Also, it is troublesome to always carry the purchased remote controller together with the camera.

### SUMMARY

Therefore, an embodiment provides an image capturing apparatus and a method of controlling the same, with which images may be captured without direct contact with a main body of the image capturing apparatus without purchasing and carrying an additional remote controller.

Additional embodiments will be set forth in part in the description which follows and, in part, will become apparent from the description, or may be learned by practice of the embodiments of the invention.

In accordance with an embodiment, a method of controlling an image capturing apparatus includes: generating a first detection signal and a second detection signal in response to motion of an object within a detection region of an ocular sensor, controlling a focusing module to bring a subject into focus in response to the generation of the first detection signal, and controlling a shutter and an imaging device to capture an image of the subject in response to the generation of the second detection signal.

The ocular sensor may generate the first detection signal when the object enters the detection region, and generate the second detection signal when the object exits the detection region.

When a time interval between a time point at which the first detection signal is generated and a time point at which the second detection signal is generated is within a predetermined range, the image of the subject may be captured in response to the second detection signal.

The ocular sensor may generate the first detection signal when the object enters the detection region, and generate the second detection signal when the object re-enters the detection region after exiting the detection region.

When a time interval between a time point at which the first detection signal is generated and a time point at which the second detection signal is generated is within a predetermined range, the image of the subject may be captured in response to the second detection signal.

The ocular sensor may generate the first detection signal when the object enters the detection region, and generate the second detection signal when the object repeatedly re-enters the detection region at least twice after exiting the detection region.

When a time interval between a time point at which the first detection signal is generated and a time point at which the second detection signal is generated is more than a predetermined time duration, the image of the subject may be captured in response to the second detection signal.

The second detection signal may be generated when the object repeatedly re-enters the detection region at least twice, and a time interval between time points at which the object repeatedly re-enters the detection region at least twice is within a predetermined range.

The method may further include generating a first control signal for controlling the focusing module to bring the subject into focus in response to the generation of the first detection signal, and generating a second control signal for controlling the shutter and the imaging device to capture the image of the subject in response to the generation of the second detection signal.

The ocular sensor may be a single ocular sensor.

In accordance with another embodiment, a method of controlling an image capturing apparatus includes: generating a first detection signal and a second detection signal in response to motion of an object in a detection region of an ocular sensor, wherein the first detection signal is generated when the object enters the detection region, and the second detection signal is detected when the object exits the detection region, controlling a focusing module to bring the subject into focus in response to the generation of the first detection signal, and controlling a shutter and an imaging device to capture an image of the subject in response to the generation of the second detection signal.

When a time interval between a time point at which the first detection signal is generated and a time point at which the second detection signal is generated is within a predetermined range, the image of the subject may be captured in response to the second detection signal.

In accordance with another embodiment, a method of controlling an image capturing apparatus includes: generating a first detection signal and a second detection signal in response to motion of an object in a detection region of an ocular sensor, wherein the first detection signal is generated when the object enters the detection region, and the second detection signal is detected when the object re-enters the detection region after exiting the detection region, controlling a focusing module to bring a subject into focus in response to the generation of the first detection signal, and controlling a shutter and an imaging device to capture an image of the subject in response to the generation of the second detection signal.

When a time interval between a time point at which the first detection signal is generated and a time point at which the second detection signal is generated is within a predetermined range, the image of the subject may be controlled in response to the second detection signal.

In accordance with embodiment, a method of controlling an image capturing apparatus includes: generating a first detection signal and a second detection signal in response to motion of an object in a detection region of an ocular sensor, wherein the first detection signal is generated when the object enters the detection region, and the second detection signal is detected when the object repeatedly re-enters the detection region at least twice after exiting the detection region, controlling a focusing module to bring a subject into focus in response to the generation of the first detection signal, and controlling a shutter and an imaging device to capture an image of the subject in response to the generation of the second detection signal.

When a time interval between a time point at which the first detection signal is generated and a time point at which the second detection signal is generated is more than a predetermined time duration, the image of the subject may be captured in response to the second detection signal.

The second detection signal may be generated when the object repeatedly re-enters the detection region at least twice, and a time interval between time points at which the object repeatedly re-enters the detection region at least twice is within a predetermined range.

In accordance with another embodiment, an image capturing apparatus includes: a lens configured to receive an image of a subject, a focusing module configured to drive the lens and bring the subject into focus, an imaging device configured to capture the image of the subject, a shutter configured to expose the image of the subject for a predetermined amount of time, an ocular sensor configured to generate a first detection signal and a second detection signal in response to motion of an object within a detection region of the ocular sensor, and a controller configured to control the focusing module to bring the subject into focus in response to the generation of the first detection signal, and control the shutter and the imaging device to capture the image of the subject in response to the generation of the second detection signal.

The image capturing apparatus may further include a viewfinder, a display unit, a first mode in which the viewfinder and the display unit are alternately enabled, and a second mode in which an image capturing function using the ocular sensor is enabled. The detection region of the ocular sensor is larger in the second mode than in the first mode.

The ocular sensor may be a single ocular sensor.

In various embodiments, images may be captured without direct contact with a main body of an image capturing apparatus to prevent shake (vibration) of the image capturing apparatus. Also, images may be captured without purchasing and carrying an additional remote controller so that the costs of the purchase of the remote controller and a burden of carrying the remote controller can be eliminated.

### BRIEF DESCRIPTION OF THE DRAWINGS

These and/or other aspects will become apparent and more readily appreciated from the following description of the embodiments, taken in conjunction with the accompanying drawings of which:

FIGS. 1(A) and 1(B) are diagrams illustrating examples of an image capturing apparatus, in accordance with an embodiment;

FIG. 2 is a diagram illustrating a control system of the image capturing apparatus shown in FIGS. 1(A) and 1(B);

FIG. 3 is a diagram illustrating an ocular sensor shown in FIGS. 1(A) and 1(B);

FIGS. 4(A) and 4(B) are diagrams illustrating an image capturing function using an ocular sensor of an image capturing apparatus, in accordance with an embodiment;

FIG. 5 is a flowchart illustrating a method of capturing an image using an ocular sensor of the image capturing apparatus shown in FIGS. 4(A) and 4(B);

FIGS. 6(A) and 6(B) are diagrams illustrating an image capturing function using an ocular sensor of an image capturing apparatus, in accordance with another embodiment;

FIG. 7 is a flowchart illustrating a method of capturing an image using the ocular sensor of the image capturing apparatus shown in FIGS. 6(A) and 6(B);

FIGS. 8(A) and 8(B) are diagrams illustrating an image capturing function using an ocular sensor of an image capturing apparatus, in accordance with another embodiment; and

FIG. 9 is a flowchart illustrating a method of capturing an image using the ocular sensor of the image capturing apparatus shown in FIGS. 8(A) and 8(B).

### DETAILED DESCRIPTION

Reference will now be made in detail to the embodiments of the invention, examples of which are illustrated in the accompanying drawings, wherein like reference numerals refer to like elements throughout.

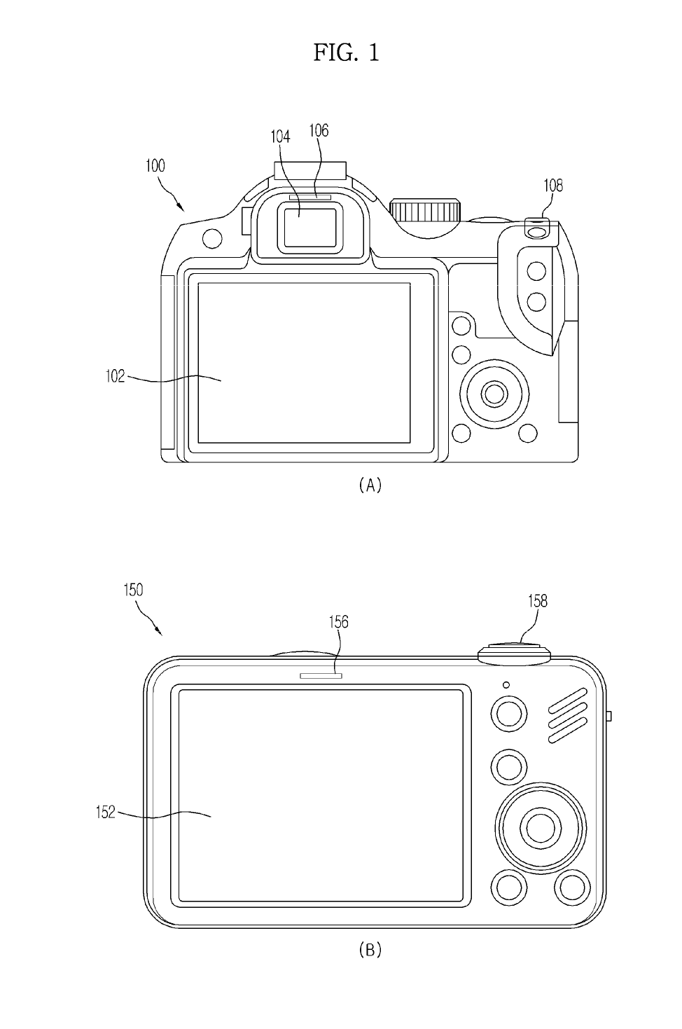

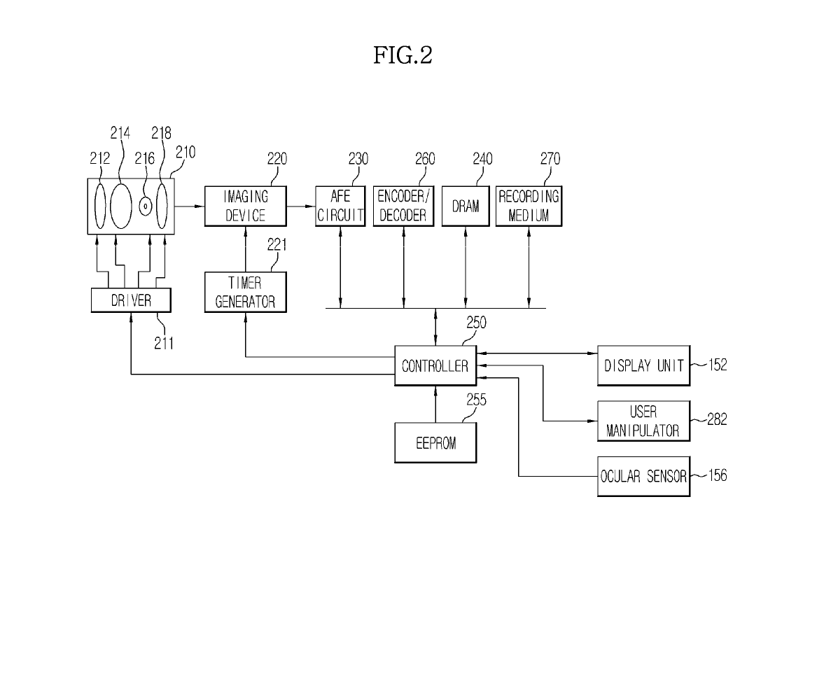

FIGS. 1(A) and 1(B) are diagrams illustrating examples of an image capturing apparatus, in accordance with an embodiment. Image capturing apparatuses 100 and 150 shown in FIGS. 1(A) and 1(B) are digital cameras configured to capture an image of a subject, convert the image into digital data, and record the digital data in a storage apparatus. Here, the image may be a still image or a moving image. FIG. 1(A) illustrates an image capturing apparatus 100 on which both a display unit 102 and a viewfinder 104 are disposed. The display unit 102 may display an image of a subject input through a lens before the image is captured, and display the captured image after the image is captured. The viewfinder 104 may show the image input through the lens. The viewfinder 104 may be an electronic viewfinder or an optical viewfinder. When the viewfinder 104 is the electronic viewfinder, the viewfinder 104 may show an image processed and digitalized by a controller (refer to 250 in FIG. 2) disposed in the image capturing apparatus 100. When the viewfinder 104 is the optical viewfinder, the viewfinder 104 may not digitalize the image input through the lens but show only an intact image transmitted through an optical system. An ocular sensor 106 may be disposed in the vicinity of the viewfinder 104. The ocular sensor 106 may generate a detection signal in response an object (e.g., a user's body part or a tool) entering into a detection region of the ocular sensor 106 or the object exiting the detection region of the ocular sensor 106. The controller 250 may alternately enable the display unit 102 and the viewfinder 104 based on the detection signal of the ocular sensor 106. For example, when the presence of the object is detected in the detection region of the ocular sensor 106, the controller 250 may disable (turn off) the display unit 102 and enable (turn on) the viewfinder 104. For instance, when a user brings his or her eye close to the viewfinder 104 to observe a subject through the viewfinder 104, the ocular sensor 106 may detect the user's eye, generate a detection signal, and transmit the detection signal to the controller 250, and the controller 250 may enable the viewfinder 104 in response to the detection signal generated by the ocular sensor 106 so that the user can confirm the subject through the viewfinder 104. Also, while the user is confirming the subject, the controller 250 may disable the display unit 102 to prevent power consumption by the display unit 102. In this state, when the user's eye becomes far from the viewfinder 104 and exits the detection region of the ocular sensor 106, the ocular sensor 106 may detect the exit of the user's eye, generate a detection signal, and transmit the detection signal to the controller 250, and the controller 250 may enable the display unit 102 in response to the detection signal generated by the ocular sensor 106 so that the user can confirm a subject or an image through the display unit 102. Also, the controller 250 may disable the viewfinder 104 to prevent power consumption by the viewfinder 104.

An embodiment proposes another method of capturing an image using an ocular sensor 106 or 156. In the image capturing apparatus 100 shown in FIG. 1(A), the capturing of images may be performed by manipulating a shutter-release button 108. The image capturing apparatus 100 may be controlled to perform a focusing operation and a shutter-release operation in response to a detection signal generated by the ocular sensor 106 so that images can be captured without contact with the image capturing apparatus 100 and without using an additional remote controller. When the focusing operation and the shutter-release operation are performed only by bringing an object close to the ocular sensor 106 without directly manipulating a shutter-release button 108, images may be captured without directly contacting a main body of the image capturing apparatus 100. As a result, shake (vibration) of the image capturing apparatus 100 may be prevented. Also, since images may be captured without purchasing and carrying an additional remote controller, the costs due to the purchase of the remote controller and the burden of carrying the remote controller may be eliminated. Also, in the image capturing apparatus 100 according to the embodiment, a focusing control operation and an image capturing operation may be performed using a single ocular sensor 106 so that various control operations, such as the focusing control operation and an image capturing control operation, can be performed without using a plurality of ocular sensors 106. By reducing the number of ocular sensors 106, an assembly process may be simplified, fabrication costs may be reduced, and the sizes and weights of products may be lessened.

FIG. 1(B) is a diagram of another image capturing apparatus 150 in accordance with an embodiment, which is a digital camera on which a viewfinder is not mounted. Before capturing an image of a subject, the image of the subject may be confirmed via a display unit 152 instead of the viewfinder. Also, the display unit 152 may show a captured image. Like the image capturing apparatus 100 shown in FIG. 1(A), the image capturing apparatus 150 shown in FIG. 1(B), on which the viewfinder is not mounted, may capture an image using an ocular sensor 156 without contact with a shutter-release button 158 or a main body of the image capturing apparatus 150.

FIG. 2 is a diagram illustrating a control system of the image capturing apparatus 100 or 150 shown in FIGS. 1(A) and 1(B). Although reference numerals of the image capturing apparatus 150 shown in FIG. 1(B) are used for brevity, the control system shown in FIG. 2 may be directly applied to the image capturing apparatus 100 shown in FIG. 1(A).

A controller 250 may execute a program recorded in an electronically erasable and programmable read-only memory (EEPROM) 255 and control the whole operation of the image capturing apparatus 150. The controller 250 may include a digital signal processor (DSP) or image processor configured to convert an analog image signal into a digital image signal and perform various conversion operations for obtaining good images.

An optical system 210 may include a plurality of optical lenses and used to form an image of a subject on an imaging surface of an imaging device 220. The optical system 210 may include a lens 212 disposed along an optical-axis direction and configured to receive the image of the subject, a shutter 214 and an iris diaphragm 216 configured to control the exposure time and quantity of light incident on the imaging device 220, and a focusing module 218 configured to control the focus of the image of the subject that is formed on the imaging surface of the imaging device 220. The lens 212, the shutter 214, the iris diaphragm 216, and the focusing module 218 may be driven by a driver 211. The focusing module 218 may include at least one focus lens. The shutter 214 of FIG. 2 may be a mechanical shutter, which may be substituted with an electronic shutter. A mechanical shutter may control a time period for which a film or the imaging surface of the imaging device 220 is exposed to light using a physical shutter layer present between the lens and the imaging surface. Another kind of a shutter is an electronic shutter. In this case, no additional shutter is prepared, but the imaging device 220 may electronically control enable/disable signals and produce the effects of an electronic shutter. Both the mechanical shutter and the electronic shutter may be used if necessary.

The imaging device 220 may be a charge-coupled device (CCD) or a complementary metal oxide semiconductor (CMOS) device and may convert the image of the subject, which is received via the optical system 210, into an electric image signal (photoelectric conversion). An operation of the imaging device 220 may be controlled by the controller 250 via a timing generator 221. A film of a film camera may correspond to the imaging device 220. In this case, photosensitization may occur in the film without causing photoelectric conversion to record an image.

An analog front-end (AFE) circuit 230 may be used to process an output signal of the imaging device 220 and may convert the output signal of the imaging device 220 into a quantized digital image signal. The AFE circuit 230 may perform sample-hold operations on the output signal of the imaging device 220 in a correlated double sampling manner to maintain a high signal-to-noise ratio (SNR), control a gain of an image signal using an auto-gain control, and perform an analog-to-digital conversion (ADC) operation so that the AFE circuit 230 can convert an analog image signal into a digital image signal.

The digital image signal converted by the AFE circuit 230 may selectively undergo an image quality correction operation and luminance/chromaticity conversion operations and be transmitted to an encoder/decoder 260, converted into encoded data according to a prescribed compression encoding method, such as Joint Photographic Experts Group (JPEG) or Moving Picture Experts Group (MPEG), and transmitted to and stored in a recording medium 270. The recording medium 270 may be used to store image data of a subject in the form of a still image or moving image file. The encoder/decoder 260 may access the image file stored in the recording medium 270 and extension-decode the image file to construct a reproduction screen of the still image or moving image. Meanwhile, a dynamic random access memory (DRAM) 240 may temporarily store the image data to provide a working region for processing signals and provide a kind of a temporary working region in which the encoder/decoder 260 may perform a compression operation and the controller 250 may perform various signal processing operations.

A display unit 152 and an ocular sensor 156 may be the same as described above with reference to FIG. 1(B). In addition, the display unit 152 may display a menu screen of the image capturing apparatus 150. For example, the display unit 152 may include a touch panel, which may have a display function and sense a user's input in the form of a touch signal. A user manipulator 282 may include a plurality of buttons provided to be manipulated by a user. The user manipulator 282 may convert a user's button manipulation into an appropriate electric signal and transmit the electric signal to the controller 250. In particular, a selection button may be prepared on the user manipulator 282 to enable an image capturing function using the ocular sensor 156. Alternatively, the menu screen displayed on the display unit 152 may enable the image capturing function using the ocular sensor 156. When the image capturing function using the ocular sensor 156 is enabled, images may be captured without manipulating a shutter-release button 158.

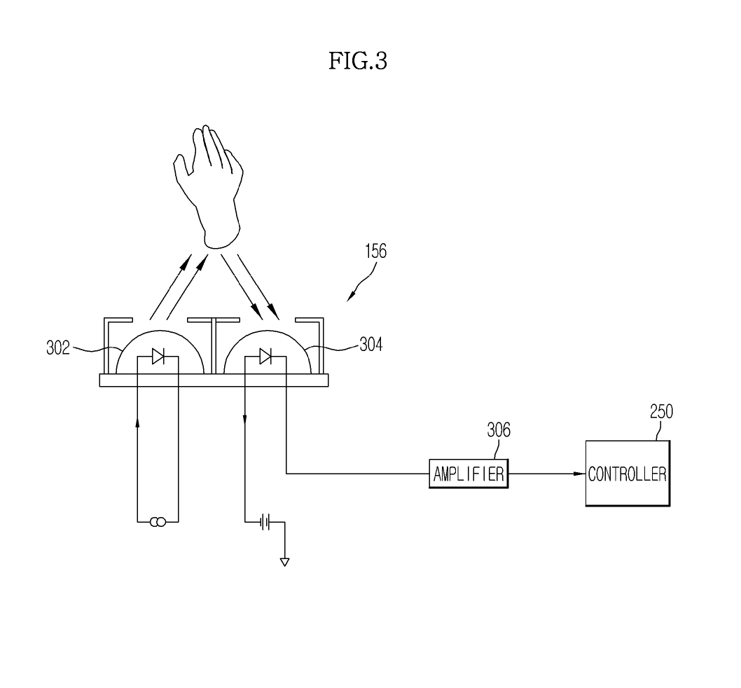

FIG. 3 is a diagram illustrating the ocular sensor 106 or 156 shown in FIGS. 1(A) and 1(B). As shown in FIG. 3, the ocular sensor 156 may include a light emitter 302 and a light receiver 304. Light irradiated by the light emitter 302 may be reflected by an object and received by the light receiver 304. The light receiver 304 may receive the reflected light and generate a detection signal. The detection signal generated by the light receiver 304 may be amplified by an amplifier 306 and transmitted to a controller 250.

According to the embodiment, in the image capturing apparatus 100 on which the viewfinder 104 is mounted as shown in FIG. 1(A), the size of the detection region of the ocular sensor 106 may be determined in consideration of the following points. That is, the size of the detection region of the ocular sensor 106 in a first mode, in which the viewfinder 104 and the display unit 102 are alternately enabled and an image capturing function using the ocular sensor 106 is not enabled, may be different from the size of the detection region of the ocular sensor 106 in a second mode, in which the image capturing function using the ocular sensor 106 is enabled. More specifically, the size of the detection region of the ocular sensor 106 in the second mode may be larger than the size of the detection region of the ocular sensor 106 in the first mode. When the image capturing function using the ocular sensor 106 is not enabled, since a user's eye becomes very close to the viewfinder 104, the size of the detection region may be relatively small (e.g., 3 cm or less). However, when the image capturing function using the ocular sensor 106 is enabled, the size of the detection region may be further increased (e.g., about 3 to 10 cm).

In the image capturing apparatus 150 of FIG. 1(B) on which a viewfinder is not mounted, the size of the detection region of the ocular sensor 156 may be determined in consideration of only the image capturing function using the ocular sensor 106.

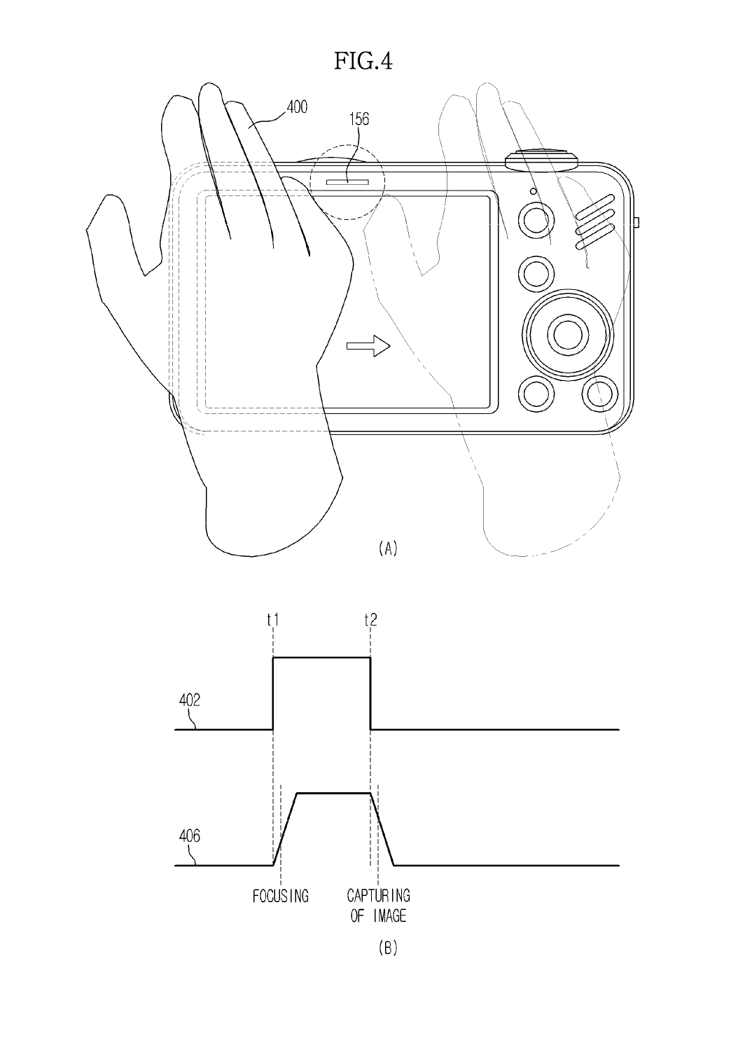

FIGS. 4(A) and 4(B) are diagrams illustrating an image capturing function using an ocular sensor 156 of an image capturing apparatus 150, in accordance with an embodiment. In the second mode in which the image capturing function using the ocular sensor 156 of the image capturing apparatus 150 is enabled, as shown in FIG. 4(A), when a user causes an object (e.g., user's hand 400) to enter a detection region of the ocular sensor 156 or exit the detection region of the ocular sensor 156, the ocular sensor 156 may detect the entrance of the object into the detection region of the ocular sensor 156 and the exit of the object from the detection region of the ocular sensor 156 and generate a detection signal 402 and a control signal 406 shown in FIG. 4(B).

In FIG. 4(B), a time point t1 of the detection signal 402 may be a time point at which a user's hand 400, which corresponds to the object, is about to enter the detection region of the ocular sensor 156, and the ocular sensor 156 begins to detect the motion of the hand 400. A rising edge of the control signal 406 may be formed in response to a rising edge (a first detection signal) formed at the time point t1 of the detection signal 402. Afterwards, when the user's hand 400 exits the detection region of the ocular sensor 156 at a time point t2 of the detection signal 402, a falling edge (a second detection signal) of the detection signal 402 may be formed. A falling edge of the control signal 406 may be formed in response to a falling edge of the detection signal 402. At the rising edge of the control signal 406, an optical system 210 (FIG. 2) may be controlled by a driver 211 (FIG. 2) to enable a focusing operation. At the falling edge of the control signal 406, the optical system 210 may also be controlled by the driver 211 to control an operation of a shutter 214 so that an image can be captured. In the case of an electronic shutter, an imaging device 220 may be controlled by a controller 250 to perform a shutter function. The captured image may be stored in the recording medium 270 and displayed on the display unit 152 via the controller 250.

A time interval between the rising edge and falling edge of the detection signal 402 shown in FIG. 4(B) (i.e., a time interval between the time points t1 and t2) should be within a predetermined range (e.g., about 1 to 2 seconds). Here, the predetermined range of the time interval may be appropriately determined in consideration of user's easy manipulations. When the time interval between the time points t1 and t2 is outside of (i.e., less than or more than) the predetermined range, even if the motion of an object is detected in front of the ocular sensor 156, the image capturing apparatus 150 may be controlled not to capture an image. That is, when an interval between the motions of the object in the detection region of the ocular sensor 156 (i.e., the time interval between the time points t1 and t2) is less than or more than the predetermined range of the time interval, the image capturing apparatus 150 may determine that the motions of the object are not manipulations for capturing an image, and may not perform an image capturing operation. In another case, when an interval between the motions of the object in the detection region of the ocular sensor 156 (i.e., the time interval between the time points t1 and t2) is within the predetermined range of the time interval, the image capturing apparatus 150 may determine that the motions of the object are manipulations for capturing an image, and perform an image capturing operation. By determining an appropriate range of the time interval between the time points t1 and t2, an image capturing function using the ocular sensor 156 may be conveniently used, and the likelihood of capturing an unnecessary image when an object moves in the detection region of the ocular sensor 156 without the user's intention may be greatly reduced.

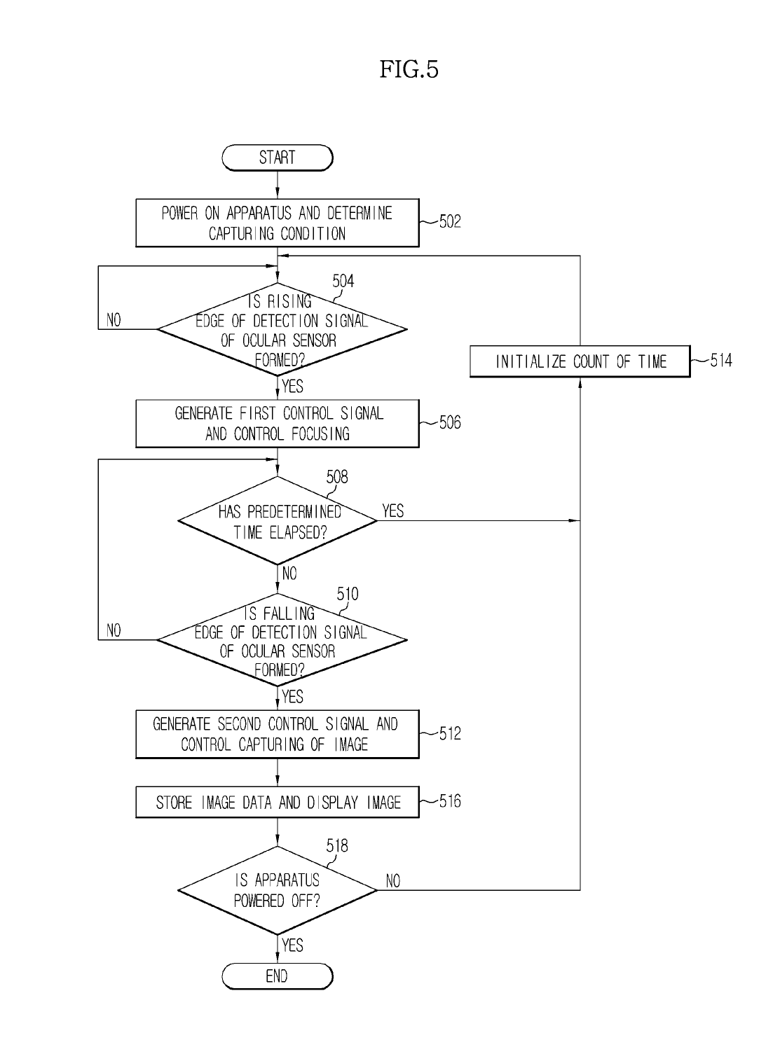

FIG. 5 is a flowchart illustrating a method of capturing an image using an ocular sensor of the image capturing apparatus 150 shown in FIGS. 4(A) and 4(B). As shown in FIG. 5, a user may power on the image capturing apparatus 150 and determine a desired image capturing condition (operation 502). Here, the determination of the image capturing condition may include enabling an image capturing function using the ocular sensor 156 of the image capturing apparatus 150.

When the entrance of an object into the detection region of the ocular sensor 156 of the image capturing apparatus 150 is detected, a rising edge of the detection signal 402 of the ocular sensor 156 may be formed (operation 504), and a rising edge of the control signal 406 may be formed in response to the rising edge of the detection signal 402 to enable a focusing control operation (506). Before a predetermined time elapses (refer to “NO” of operation 508) from a time point at which the rising edge of the detection signal 402 is formed, when the exit of the object from the detection region of the ocular sensor 156 is detected and the falling edge of the detection signal 402 of the ocular sensor 156 is formed (refer to “YES” of operation 510), the falling edge of the control signal 406 may be formed in response to the falling edge of the detection signal 402, and an image capturing control operation may be performed in response to the formation of the falling edge of the control signal 406 (operation 512). Here, the predetermined time refers to the predetermined range of the time interval described above with reference to FIG. 4(B). In operation 508, if the predetermined time has not elapsed (refer to “YES” of operation 508) (i.e., the falling edge of the detection signal 402 of the ocular sensor 156 is not formed during the focusing control operation), an image capturing operation may not be performed and a counted time may be initialized (operation 514). The process may return to an operation following operation 502 of powering on the image capturing apparatus 150 and determining the desired capturing condition.

The controller 250 may store data regarding the image captured in operation 512 in the recording medium 270, and display the captured image via the display unit 152 when an image display function using the display unit 152 is enabled (operation 516). Afterwards, when the user powers off the image capturing apparatus 150, the operation of the image capturing apparatus 150 may end (refer to “YES” of operation 518). When the image capturing apparatus 150 remains powered on (refer to “NO” of operation 518), the count of a time required to control the ocular sensor 156 may be initialized (operation 514), and the process may return to the operation following operation 502 of powering on the image capturing apparatus 150 and determining the image capturing condition.

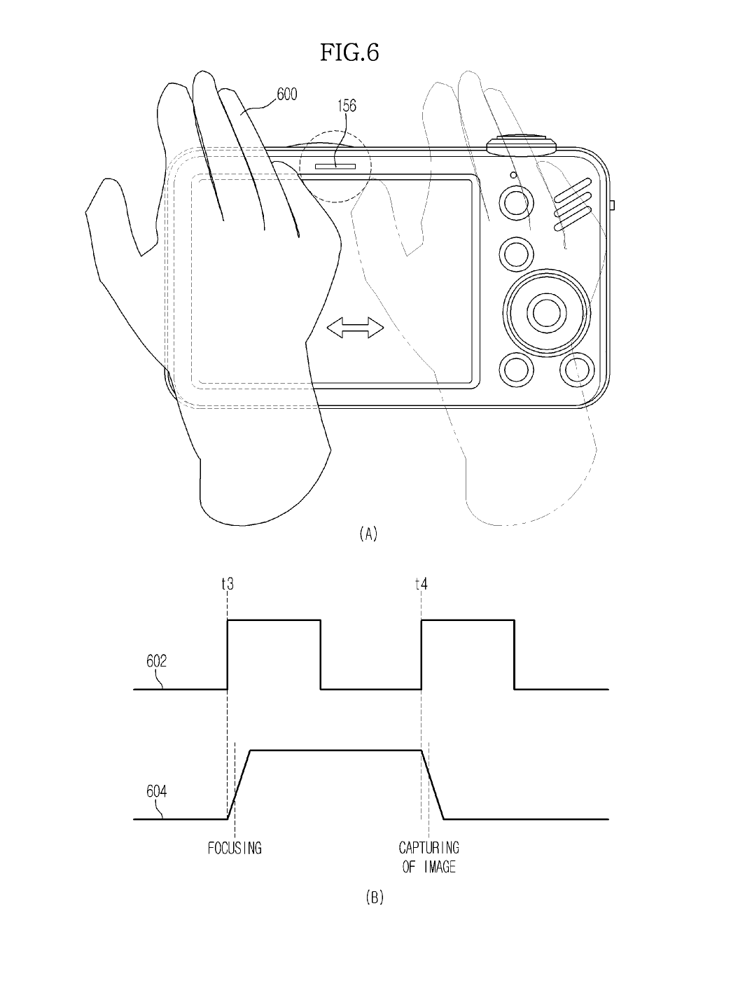

FIGS. 6(A) and 6(B) are views illustrating an image capturing function using an ocular sensor 156 of an image capturing apparatus 150, in accordance with another embodiment. In a second mode in which an image capturing function using the ocular sensor 156 of the image capturing apparatus 150 is enabled, as shown in 6(A), when a user moves an object (e.g., user's hand 600) and causes the object to enter a detection region of the ocular sensor 156 twice in succession, the ocular sensor 156 may detect two successive entrances of the object into the detection region of the ocular sensor 156 and generate a detection signal 602 and a control signal 604 as shown in FIG. 6(B). However, when the ocular sensor 156 detects an object entering the detection region twice in succession, the same object may not necessarily have entered the detection region twice, but two different objects may have entered the detection region at two times. For example, a left hand may enter the detection region a first time, and a right hand may enter the detection region a second time. FIG. 6(A) illustrates that a user moves his or her hand 600, which is a user's body part, from the left to the right once and then moves the hand 600 from the right to the left. FIG. 6(B) illustrates that the ocular sensor 156 generates the detection signal 602 in response to the two successive entrance of the user's hand 600 into the detection region, and the controller 250 generates the control signal 604 in response to the detection signal 602 to enable focusing and image capturing operations.

In FIG. 6(B), a time point t3 of the detection signal 602 is a time point at which the user's hand 600, which is an object, first enters the detection region, and the ocular sensor 156 begins to detect the first entrance of the hand 600. A first rising edge of the control signal 604 may be formed in response to a rising edge (or a first detection signal) formed at the time point t3 of the detection signal 602. Afterwards, when the user's hand 600 exits the detection region and then enters the detection region of the ocular sensor 156 for a second time at a time point t4 of the detection signal 602, at which a second rising edge (or a second detection signal) of the detection signal 602 may be formed. A falling edge of the control signal 604 may be formed in response to the second rising edge of the detection signal 602. At the rising edge of the control signal 604, an optical system 210 (FIG. 2) may be controlled by a driver 211 (FIG. 2) to enable a focusing operation. At the falling edge of the control signal 604, the optical system 210 may also be controlled by the driver 211 to control an operation of a shutter 214 so that an image can be captured. In the case of an electronic shutter, an imaging device 220 may be controlled by the controller 250 to perform a shutter function. The captured image may be stored in the recording medium 270 and displayed on the display unit 152 via the controller 250.

A time interval between the first rising edge and second rising edge of the detection signal 602 shown in FIG. 6(B) (i.e., a time interval between the time points t3 and t4) should be within a predetermined range (e.g., about 1 to 2 seconds). Here, the predetermined range of the time interval may be appropriately determined in consideration of a user's easy manipulations. When the time interval between the time points t3 and t4 is outside of (i.e., less than or more than) the predetermined range, even if repetitive motions of an object are detected in front of the ocular sensor 156, the image capturing apparatus 150 may be controlled not to capture an image. That is, when an interval between successive motions of the object in the detection region of the ocular sensor 156 (i.e., the time interval between the time points t3 and t4) is less than or more than the predetermined range of the time interval, the image capturing apparatus 150 may determine that the successive motions of the object are not manipulations for capturing an image, and may not perform an image capturing operation. In another case, when an interval between the successive motions of the object in the detection region of the ocular sensor 156 (i.e., the time interval between the time points t3 and t4) is within the predetermined range of the time interval, the image capturing apparatus 150 may determine that the motions of the object are manipulations for capturing an image, and perform an image capturing operation. By determining an appropriate range of the time interval between the time points t3 and t4, an image capturing function using the ocular sensor 156 may be conveniently used, and the likelihood of capturing an unnecessary image when an object moves in the detection region of the ocular sensor 156 without the user's intention may be greatly reduced.

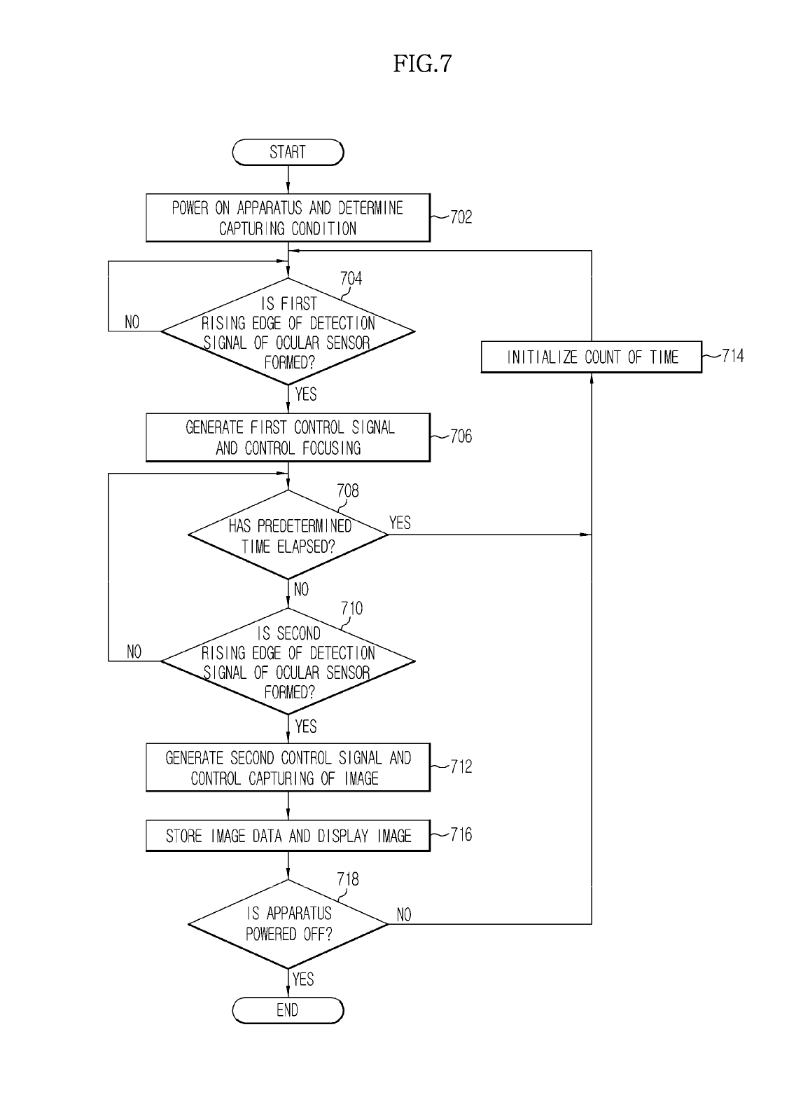

FIG. 7 is a flowchart illustrating a method of capturing an image using the ocular sensor 156 of the image capturing apparatus 150 shown in FIGS. 6(A) and 6(B). As shown in FIG. 7, a user may power on the image capturing apparatus 150 and determine a desired capturing condition (operation 702). Here, the determination of the capturing condition may include enabling an image capturing function using the ocular sensor 156 of the image capturing apparatus 150.

When a first entrance of an object into the detection region of the ocular sensor 156 of the image capturing apparatus 150 is detected, a first rising edge of the detection signal 602 of the ocular sensor 156 may be formed (operation 704), and a rising edge of the control signal 604 may be formed in response to the first rising edge of the detection signal 602 to enable a focusing control operation (706). Before a predetermined time elapses (refer to “NO” of operation 708) from a time point at which the first rising edge of the detection signal 602 is formed, when a second entrance of the object to the detection region of the ocular sensor 156 is detected and the second rising edge of the detection signal 602 of the ocular sensor 156 is formed (refer to “YES” of operation 710), the falling edge of the control signal 604 may be formed in response to the second rising edge of the detection signal 602, and an image capturing control operation may be performed in response to the formation of the rising edge of the control signal 604 (operation 712). Here, the predetermined time refers to the predetermined range of the time interval described above with reference to FIG. 6(B). In operation 708, if the predetermined time has not elapsed (refer to “YES” of operation 708) (i.e., the second rising edge of the detection signal 602 of the ocular sensor 156 is not formed during the focusing control operation), an image capturing operation may not be performed, a counted time may be initialized (operation 714). The process may return to an operation following the operation 702 of powering on the image capturing apparatus 150 and determining the desired capturing condition.

The controller 250 may store data regarding the image captured in operation 712 in the recording medium 270, and display the captured image via the display unit 152 when an image display function using the display unit 152 is enabled (operation 716). Afterwards, when the user powers off the image capturing apparatus 150, the operation of the image capturing apparatus 150 may end (refer to “YES” of operation 718). When the image capturing apparatus 150 remains powered on (refer to “NO” of operation 718), the count of a time required to control the ocular sensor 156 may be initialized (operation 714), and the process may return to the operation following operation 702 of powering on the image capturing apparatus 150 and determining the image capturing condition.

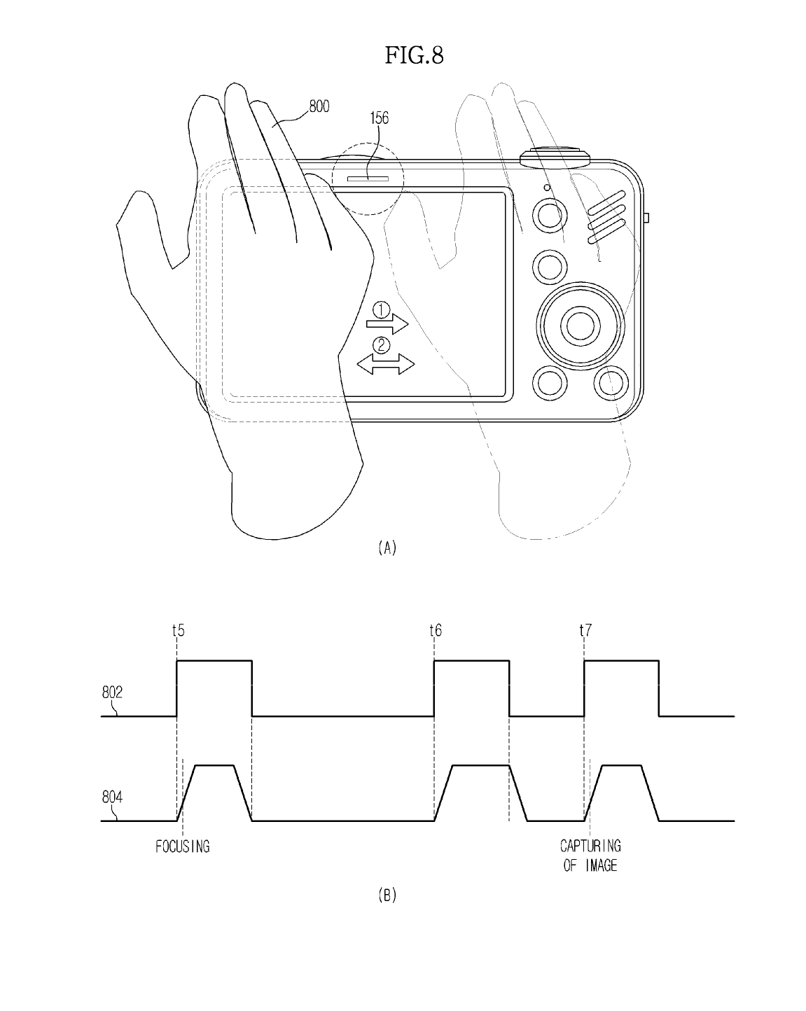

FIGS. 8(A) and 8(B) are diagrams illustrating an image capturing function using an ocular sensor 156 of an image capturing apparatus 150, in accordance with another embodiment. In a second mode in which an image capturing function using the ocular sensor 156 of the image capturing apparatus 150 is enabled, as shown in FIG. 8(A), when a user moves an object (e.g., user's hand 800) and causes the object to first enter a detection region of the ocular sensor 156, exit the detection region, and enter the detection region again twice in succession after a predetermined time has elapsed, the ocular sensor 156 may detect the movement of the object with respect to the detection region and generate a detection signal 802 and a control signal 804 as shown in FIG. 8(B). In this case, the object may first enter the detection region of the ocular sensor 156 (refer to \textcircled{1} in FIG. 8(A)), exit the detection region, and re-enter the detection region again twice in succession (refer to \textcircled{2} in FIG. 8(A)). However, when the ocular sensor 156 detects an object passing the detection region several times, the same object may not necessarily have entered the detection region, but different objects may have entered the detection region at respective times. For example, a left hand may enter the detection region a first time, and a right hand may enter the detection region a second time. FIG. 8(A) illustrates that a user moves his or her hand 800, which is a user's body part, from the left side of the ocular sensor 156 to the right thereof (refer to \textcircled{1} in FIG. 8(A)) and then moves the hand 800 from side to side (refer to \textcircled{2} in FIG. 8(A)). FIG. 8(B) illustrates that the ocular sensor 156 detects one-directional movement and bi-directional movement of the user's hand 800 and generates the detection signal 802, and the controller 250 generates the control signal 804 in response to the detection signal 802 to enable focusing and image capturing operations.

In FIG. 8(B), a time point t5 of the detection signal 802 may be a time point at which the user's hand 800 of FIG. 8(A) first enters the detection region of the ocular sensor 156, and the ocular sensor 156 begins to detect the first entrance of the hand 800. A first rising edge of the control signal 804 may be formed in response to a first rising edge (or a first detection signal) formed at the time point t5 of the detection signal 802. The detection signal 802 may form a pulse signal having a high-level period with a predetermined duration after the first rising edge is formed. Afterwards, when the user's hand 800 exits the detection region and then repeatedly re-enters the detection region of the ocular sensor 156 (e.g., twice), the ocular sensor 156 may detect the two re-entrances of the hand 800, and a plurality of second rising edges may be formed at time points t6 and t7 of the detection signal 802. The time points t6 and t7 of the detection signal 802 may be respective time points at which the user's hand 800 repeatedly re-enters the detection region of the ocular sensor 156 two times. A plurality of second rising edges of the control signal 804 may be formed in response to the plurality of second rising edges of the detection signal 802. In FIG. 8(B), at the rising edge of the control signal 804 (the time point t5), an optical system 210 (FIG. 2) may be controlled by a driver 211 (FIG. 2) to enable a focusing operation. At a final rising edge (the time point t7) of the plurality of second rising edges of the control signal 804, the optical system 210 may also be controlled by the driver 211 to control an operation of a shutter 214 so that an image can be captured. The captured image may be stored in the recording medium 270 and displayed on the display unit 152 via the controller 250.

In FIG. 8(B), each of a time interval between the time points t5 and t6 and a time interval between the time points t6 and t7 should be within a predetermined range. For instance, the time interval between the time points t5 and t6 may be about 5 seconds or more, and the time interval between the time points t6 and t7 may be between about 1 second and 3 seconds. Here, a predetermined time interval and the predetermined range of the time interval may be appropriately determined in consideration of a user's easy manipulations. That is, when the time interval between the time points t5 and t6 is a predetermined time duration (e.g., 5 seconds) or more and the time interval between the time points t6 and t7 is between about 1 second and 3 seconds, a subject focusing operation and an image capturing operation may be performed normally. When the time interval between the time points t5 and t6 is less than the predetermined time duration (of about 5 seconds) and the time interval between the time points t6 and t7 is outside of the predetermined range (of between 1 second and 3 seconds), even if the motion of an object is detected in front of the ocular sensor 156, the image capturing apparatus 150 may be controlled not to capture an image. That is, when the motion of the object in the front of the ocular sensor 156 is not a prearranged action as shown in FIGS. 8(A) and 8(B), the image capturing apparatus 150 may determine that the motion of the object is not a manipulation for capturing an image, and may not perform an image capturing operation. Thus, an image capturing function using the ocular sensor 156 may be conveniently used, and the likelihood of capturing an unnecessary image when an object moves in the detection region of the ocular sensor 156 without the user's intention may be greatly reduced.

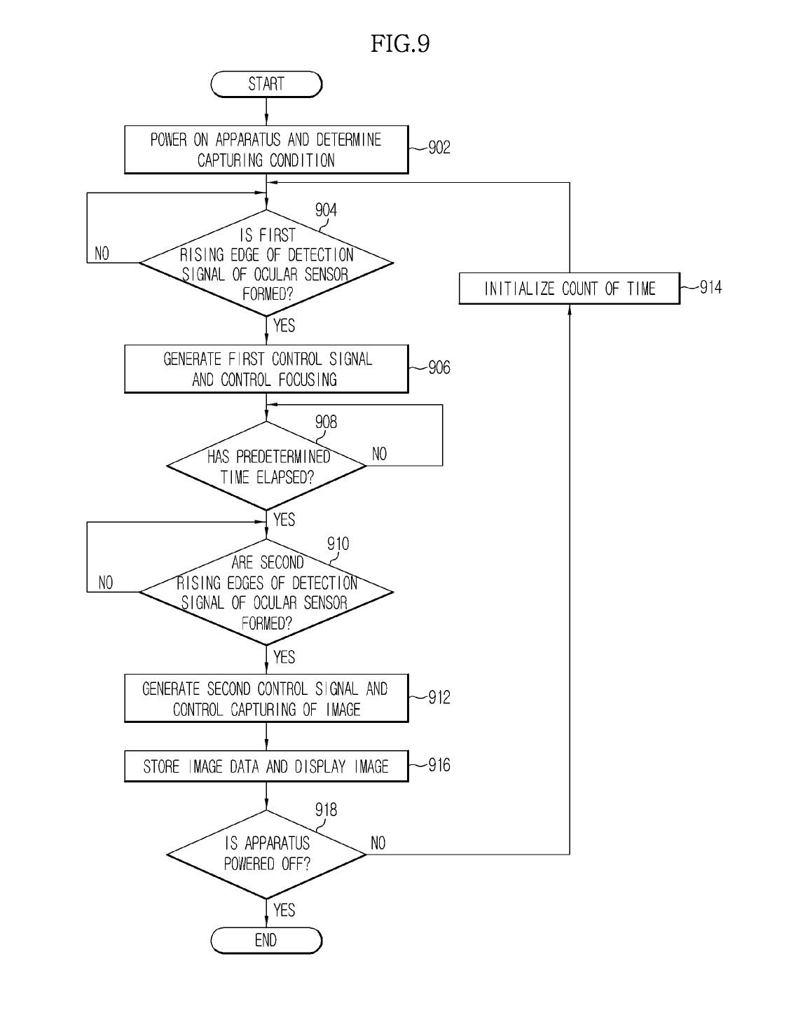

FIG. 9 is a flowchart illustrating a method of capturing an image using the ocular sensor 156 of the image capturing apparatus 150 shown in FIGS. 8(A) and 8(B). As shown in FIG. 9, a user may power on the image capturing apparatus 150 and determine a desired capturing condition (operation 902). Here, the determination of the capturing condition may include enabling an image capturing function using the ocular sensor 156 of the image capturing apparatus 150.

When bi-directional movement of an object is detected by the ocular sensor 156 in front of the ocular sensor 156 of the image capturing apparatus 150, the first rising edge of the detection signal 802 of the ocular sensor 156 may be formed at a time point t5 (operation 904), and the rising edge of the control signal 804 may be formed in response to the first rising edge of the detection signal 802 to perform a focusing control operation (operation 906). After a predetermined time has elapsed from the time point t5 at which the first rising edge of the detection signal 802 is formed (refer to “YES” of operation 908), when another motion of the object in an opposite direction is detected by the ocular sensor 156, the second rising edge of the detection signal 802 of the ocular sensor 156 is formed (refer to “YES” of operation 910). The second rising edge of the control signal 804 may be formed in response to the second rising edge of the detection signal 802, and an image capturing control operation may be performed in response to the formation of the second rising edge of the control signal 804 (operation 912). Here, the predetermined time refers to the predetermined range of the time interval described above with reference to FIG. 8(B). In operation 908, if the predetermined time has not elapsed (refer to “NO” of operation 908) (i.e., the second rising edge of the detection signal 802 of the ocular sensor 156 is not formed during the focusing control operation), the image capturing apparatus 150 may be on standby until the predetermined time elapses.

The controller 250 may store data regarding the image captured in operation 912 in the recording medium 270, and display the captured image via the display unit 152 when an image display function using the display unit 152 is enabled (operation 916). Afterwards, when the user powers off the image capturing apparatus 150, the operation of the image capturing apparatus 150 may end (refer to “YES” of operation 918). When the image capturing apparatus 150 remains powered on (refer to “NO” of operation 918), the count of a time required to control the ocular sensor 156 may be initialized (operation 914), and the process may return to the operation following operation 902 of powering on the image capturing apparatus 150 and determining the image capturing condition.

Although a few embodiments have been shown and described, it would be appreciated by those skilled in the art that changes may be made in these embodiments without departing from the principles and spirit of the invention, the scope of which is defined in the claims and their equivalents.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A method of controlling an image capturing apparatus, the method comprising:
generating a first detection signal and a second detection signal in response to motion of an object within a detection region of an ocular sensor;
controlling a focusing module to bring a subject into focus in response to the generation of the first detection signal; and
controlling a shutter and an imaging device to capture an image of the subject in response to the generation of the second detection signal.

2. The method according to claim 1, wherein the first detection signal is generated by the ocular sensor when the object enters the detection region, and the second detection signal is generated when the object exits the detection region.

3. The method according to claim 2, wherein, when a time interval between a time point at which the first detection signal is generated and a time point at which the second detection signal is generated is within a predetermined range, capturing the image of the subject in response to the second detection signal.

4. The method according to claim 1, wherein the first detection signal is generated by the ocular sensor when the object enters the detection region, and the second detection signal is generated when the object re-enters the detection region after exiting the detection region.

5. The method according to claim 4, wherein, when a time interval between a time point at which the first detection signal is generated and a time point at which the second detection signal is generated is within a predetermined range, capturing the image of the subject in response to the second detection signal.

6. The method according to claim 1, wherein the first detection signal is generated by the ocular sensor when the object enters the detection region, and the second detection signal is generated when the object repeatedly re-enters the detection region at least twice after exiting the detection region.

7. The method according to claim 6, wherein, when a time interval between a time point at which the first detection signal is generated and a time point at which the second detection signal is generated is more than a predetermined time duration, capturing the image of the subject in response to the second detection signal.

8. The method according to claim 7, wherein the second detection signal is generated when the object repeatedly re-enters the detection region at least twice, and a time interval between time points at which the object repeatedly re-enters the detection region at least twice is within a predetermined range.

9. The method according to claim 1, further comprising:
generating a first control signal for controlling the focusing module to bring the subject into focus in response to the generation of the first detection signal; and
generating a second control signal for controlling the shutter and the imaging device to capture the image of the subject in response to the generation of the second detection signal.

10. The method according to claim 1, wherein the ocular sensor is a single ocular sensor.

11. A method of controlling an image capturing apparatus, the method comprising:
generating a first detection signal and a second detection signal in response to motion of an object in a detection region of an ocular sensor, wherein the first detection signal is generated when the object enters the detection region, and the second detection signal is detected when the object exits the detection region;
controlling a focusing module to bring a subject into focus in response to the generation of the first detection signal; and
controlling a shutter and an imaging device to capture an image of the subject in response to the generation of the second detection signal.

12. The method according to claim 11, wherein, when a time interval between a time point at which the first detection signal is generated and a time point at which the second detection signal is generated is within a predetermined range, capturing the image of the subject in response to the second detection signal.

13. A method of controlling an image capturing apparatus, the method comprising:
generating a first detection signal and a second detection signal in response to motion of an object in a detection region of an ocular sensor, wherein the first detection signal is generated when the object enters the detection region, and the second detection signal is detected when the object re-enters the detection region after exiting the detection region;
controlling a focusing module to bring a subject into focus in response to the generation of the first detection signal; and
controlling a shutter and an imaging device to capture an image of the subject in response to the generation of the second detection signal.

14. The method according to claim 13, wherein, when a time interval between a time point at which the first detection signal is generated and a time point at which the second detection signal is generated is within a predetermined range, capturing the image of the subject in response to the second detection signal.

15. A method of controlling an image capturing apparatus, the method comprising:
generating a first detection signal and a second detection signal in response to motion of an object in a detection region of an ocular sensor, wherein the first detection signal is generated when the object enters the detection region, and the second detection signal is detected when the object repeatedly re-enters the detection region at least twice after exiting the detection region;
controlling a focusing module to bring a subject into focus in response to the generation of the first detection signal; and
controlling a shutter and an imaging device to capture an image of the subject in response to the generation of the second detection signal.

16. The method according to claim 15, wherein, when a time interval between a time point at which the first detection signal is generated and a time point at which the second detection signal is generated is more than a predetermined time duration, capturing the image of the subject in response to the second detection signal.

17. The method according to claim 16, wherein the second detection signal is generated when the object repeatedly re-enters the detection region at least twice, and a time interval between time points at which the object repeatedly re-enters the detection region at least twice is within a predetermined range.

18. An image capturing apparatus comprising:
a lens configured to receive an image of a subject;
a focusing module configured to drive the lens and bring the subject into focus;
an imaging device configured to capture the image of the subject;
a shutter configured to expose the image of the subject for a predetermined amount of time;
an ocular sensor configured to generate a first detection signal and a second detection signal in response to motion of an object within a detection region of the ocular sensor; and
a controller configured to control the focusing module to bring the subject into focus in response to the ocular sensor generating the first detection signal, and control the shutter and the imaging device to capture the image of the subject in response to the ocular sensor generating the second detection signal.

19. The apparatus according to claim 18, further comprising:
a viewfinder;
a display unit;
a first mode in which the viewfinder and the display unit are alternately enabled; and
a second mode in which an image capturing function using the ocular sensor is enabled,
wherein the detection region of the ocular sensor is larger in the second mode than in the first mode.

20. The apparatus according to claim 18, wherein the ocular sensor is a single ocular sensor.
